(19) United States
(12) Patent Application Publication
(10) Pub. No.: US 2011/0320043 A1
(43) Pub. Date: Dec. 29, 2011

(54) Determining Identifying Information Of A Cooling Fan

(76) Inventors: Andrew John Mikuszewski, Houston, TX (US); Gregory P. Ziamik, Houston, TX (US)

(21) Appl. No.: 13/255,104

(22) PCT Filed: Mar. 9, 2009
(86) PCT No.: PCT/US09/36530

§ 371 Date: Sep. 6, 2011

(51) Int. Cl. G06F 1/20; G05D 23/19; G06F 3/00

(52) U.S. Cl. 700/275; 710/16

(57) ABSTRACT

A method and device for determining identifying information about a system cooling fan (120) for use in a computing system (110) is provided. In one embodiment, a computing system, including the cooling fan, is powered on. Cooling fan identification information is transmitted through a cooling fan tachometer line at a predetermined period after powering on the computing system. The cooling fan identification information is received through the cooling fan tachometer line (160) at a processing component of the computing system.

### BACKGROUND

Computer systems generally include a board with various computer chips, a storage device, a power device, and input or output devices. Each of these components can generate heat during operation in a computer. A temperature range for some components, such as a processor, is often indicated by specifications indicative of satisfactory and/or optimum performance. Often, one or more cooling fans are provided for use with electrical components in a computer system to keep temperatures in the system within the specified temperature range.

In some computer systems, it is desirable to use multiple cooling fans for cooling electrical components. For example, a computer system can include multiple processors each having a separate cooling fan. Cooling fan speeds can be controllable by a program embedded in the system Basic Input/Output System (BIOS) code. The speed of the cooling fan(s) can be controlled by pulsing a supply voltage to the fan. The pulse supplied to the fan(s) can vary in width, amplitude, and frequency, which varies fan operation (such as speed of rotation).

Cooling fans can be manufactured by different manufacturers and can include different designs that each has specific supply voltage characteristic requirements for optimum performance. However, the computer system may have to work with a variety of cooling fans, and parameters for controlling the fan supply may vary from fan to fan. In not using optimum parameters for a cooling fan, the cooling fan can run faster than necessary, operate for a longer duration than necessary, or use more power than necessary. Additionally, cooling fan operation may create a greater amount of noise than necessary if optimum parameters are not used. or a system cooling fan can also be insufficient to provide proper cooling for certain computing components resulting in damage to the components.

Identifying system cooling fan information can be time consuming and can be subject to human error. Proper identification of a system cooling fan information may save time, money, and energy, as well as ensure that a computing system is using a cooling fan sufficient to cool the computing components.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a schematic representation of a computer system and cooling fan accordance with an embodiment of the invention;

FIG. 2 is a flow diagram of a method for determining identifying information about a system cooling fan in accordance with an embodiment of the invention; and

FIG. 3 is a schematic representation of a computer system and cooling fan in accordance with another embodiment of the invention;

FIG. 4 is a flow diagram of an alternative method. for determining identifying information about a system cooling fan in accordance with an embodiment of the invention; and

FIG. 5 is a schematic representation of a computer system and cooling fan in accordance with another embodiment of the invention.

### DETAILED DESCRIPTION

Reference will now be made to the exemplary embodiments illustrated, and specific language will be used herein to describe the same It will nevertheless be understood that no limitation of the scope of the invention is thereby intended. It is also noted that the drawings are merely schematic and are not to scale, and further, excludes depiction of various components that would also be present in a computer system.

As used herein, a plurality of items, structural elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Further, the present disclosure is drawn to a methods and devices for determining identifying information of a cooling fan. That being said, it is noted that when discussing the present devices or methods, each of these discussions can be considered applicable to each of these embodiments, whether or not they are explicitly discussed in the context of that embodiment. Thus, for example, in discussing aspects of a tachometer line in one embodiment, that discussion is applicable to other embodiments that utilize a tachometer line, and vice versa.

With this in mind, the present disclosure is drawn to a method for determining identifying information about a system cooling fan for use in a computing system. This method can comprise the steps of powering on the computing system, including the cooling fan, transmitting cooling fan identification information through a cooling fan tachometer line at a predetermined period after powering on the computing system, and receiving the cooling fan identification information through the cooling fan tachometer line at a processing component of the computing system.

Alternatively, a method for determining identifying information about a cooling fan for use in a computing system can comprise transmitting an invalid pulse width modulation value from the computing system to the cooling fan through a cooling fan pulse width modulation line, and transmitting cooling fan identification information from the cooling fan through a cooling fan tachometer line in response to the invalid pulse width modulation value. An additional step can include receiving the cooling fan identification information at a processing component of the computing system through the cooling fan tachometer line.

In another embodiment, a cooling fan system for use in a computing system and capable of transmitting identifying information can comprise a cooling fan configured to provide cooling in a computing system, and a fan connector connected to the cooling fan and coupleable to the computing system. The fan can be configured to transmit information between the cooling fan and the computing system and comprising at least five connector pins. Some of at least five connector pins can include a first connector pin is configured to connect to an electrical ground, a second connector pin is configured to provide a voltage to the cooling fan, and a third connector pin is configured to communicate rotation information of the cooling fan to the computing system. Additional pins can include a fourth connector pin is configured. to communicate an identification request from the computing system to the fan identification module, and a fifth connector pin is configured to communicate fan identification information from the fin identification module to the computing system.

In these methods and devices, it is noted that cooling fans are often used for active cooling and may be operable to move heated air away from computing components while drawing cooler air over the components. Such cooling fan systems also can include heat sinks to help dissipate heat from the processor. Using a heat sink in combination with a cooling fan can increase the area of a heated component surface in contact with the air and improve cooling efficiency. Frequently, heat sink and cooling fan combinations are available as a single unit, or alternatively, cooling fan and heat sink specifications are matched together to achieve a more optimal cooling efficiency.

Prior solutions for ensuring installation of a properly suited fan and/or heat sink involve a person, such as at a factory, manually checking the heat sink, the fan, and/or the processor or other computing components. This method allows ample opportunity for human error. For example, the wrong fan may be installed in a computer system, or the system may be incorrectly checked after it is built.

The system and method described herein allow a computer system, or an element thereof (such as a BIOS). to ensure that the correct fan and/or heat sink is installed in the system by identifying specific information about the fan. Also, by tying a particular fan to a particular heat sink, the BIOS can also ensure that a correct heat sink is installed in the system. As different fans may run at different speeds, knowing the vendor and model of a fan can allow the BIOS to optimize a fan control solution for the particular fan. A system BIOS can be a more reliable means of checking a fan and processor than the factory. Also, beyond the factory, if the user installs a higher power processor, a system BIOS can alert a user that the user needs to update the fan. A majority of computing components are now identifiable by a computer system without the need for physical human inspection of the component. A system cooling fan remains one of the few components generally not recognizable or identifiable by the computer system.

System cooling fans typically include three- or four-pin connectors for connecting the fan to the computing system. The fan connector can be connected to a motherboard or other circuit board. of the computing system. The fan connector may generally be a rectangular in-line female connector. Atypical three-pin fan connector may be on the end of a cable or wire bundle having three wires connected on the other end to the fan (or vice versa). A first connector and corresponding wire may be used as an electrical ground. A second connector and corresponding wire may provide a voltage to operate the fan (such as +12 V or +5 V). A third connector and corresponding wire may provide a tachometer signal for communicating fin speed information, such as rotations per minute (RPM). A typical four-pin fan connector may include the same wires, pins, and. functions as the three-pin fan connector with regards to three of the four connectors and wires. A fourth connector and corresponding wire may be used for pulse-width modulation of the cooing fan.

Pulse-width modulation (PWM) of a cooling fan signal or power source involves the modulation of its duty cycle, to either convey information over a communications channel or control the amount of power sent to a load. PWM can provide a more variable speed fan control mechanism than other methods, such as a potentiometer. Instead of supplying a varying voltage to a cooling fan as in the case of a potentiometer, PWM supplies the cooling fan with a fixed voltage value (such as 12V) which can start the fan spinning immediately. The voltage is then removed and the fan ‘coasts’. other words, the fan is typically powered only for the duration of the pulse. Between pulses, power to the fan is turned off (though typically the fan continues spinning even during the time period between applications of PWM pulses). The duty cycle of the PWM pulse train being provided to the fan determines the fan's speed. PWM may involve rapidly switching the fan on and off, for example 30 times a second or 30Hz. In one example, PWM values may range from 0-127 or 1-127, with a value of 127 representing the fan operating at a full or 100% duty cycle.

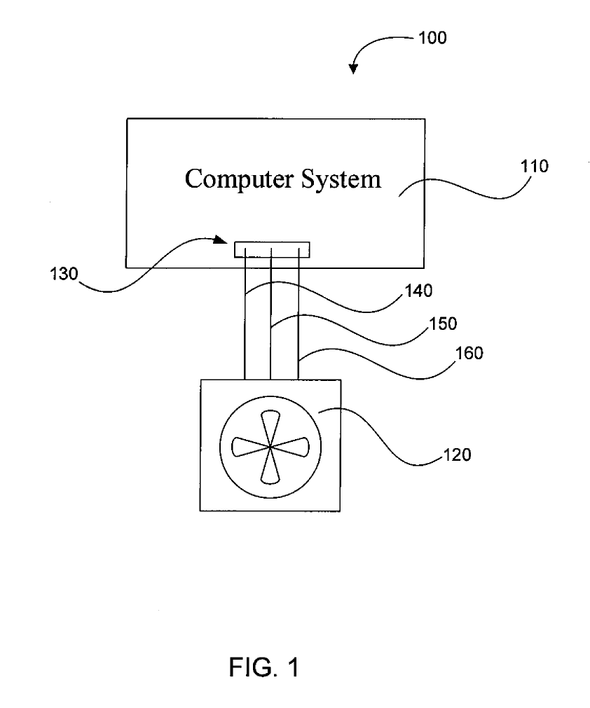

In accordance with embodiments of the present disclosure, and as illustrated in FIG. 1, a system, indicated generally at 100, provides an example embodiment in accordance with the invention, which resembles a traditional three-pin connector cooling fan 120 connected to a computer system 110. The cooling fan is connected. to a connection port 130 on the computer system. As described above, the three-pin connector can also include a. wire for an electrical ground 140, a wire for providing a. voltage 150, and a wire for transmitting speed information 160. The wire for transmitting speed information is often referred to as a speed sensor wire or a tachometer line or wire.

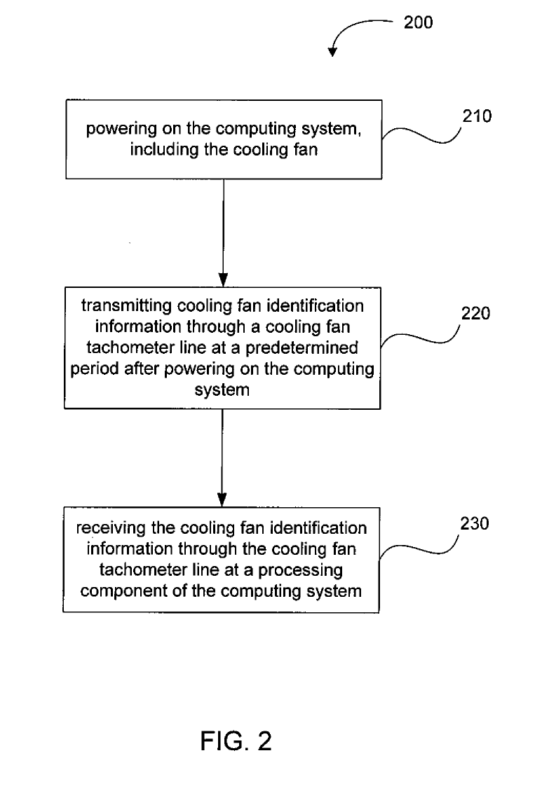

Reference will now be made to FIGS. 1 and 2. In accordance with one embodiment, the invention provides a method 200 for determining identifying information about a system cooling fan 120 for use in a computer system 110. In a first step 210, the computing system is powered on. The cooling fan, being connected to the computing system, receives power through the electrical potential difference of wires 140 and 150.

In another step 220, cooling fan identification information is sent or transmitted through the cooling fan tachometer line 160 at a predetermined period after powering on the computing system 110. The cooling fan tachometer line is used for transmitting signals from a speed sensor on the cooling fan 120. In one aspect, cooling fan identification information can be sent as a series of coded tachometer signals readable by the computing system. The coded tachometer signals can provide various identifying information about the system cooling fan. Some examples of information that can be transmitted can include manufacturer information, fan model information, part number(s), serial number(s), identification of the place and/or time and date of manufacture, an anticipated fan rotational speed, the amount of time the fan has been powered on, other general operational statistics, and more. At least some of the information may be hardwired into the cooling fan. In another aspect, at least some of the information may be stored on a storage component on the fan, such as flash random access memory (RAM). Various methods and devices for storing such information can be understood by one having skill in the art.

In another method step 230, the transmitted cooling fan identification information may be received through the cooling fan tachometer line 160 at a processing component of the computing system 110. In one example, the processing component is a system BIOS of the computer system. The computer system can use the received cooling fan identification information to determine sufficiency of the cooling fan to cool the computing system. In systems having a combination fan and heat sink (not shown) installed, the computing system may identify a heat sink by identifying a cooling fan associated with the heat sink. For example, the computing system may have a database, or access to a database, including information about which heat sinks are combined with which cooling fans, such that reference to a particular cooling fan will provide heat sink identification information. In another example, the signal transmitted from the cooling fan may include heat sink identification information. By positively identifying a heat sink, the computing system is able to determine sufficiency of the heat sink to dissipate heat from a processor or other computing component.

As described above, in step 220, cooling fan 120 identification information is sent or transmitted. through the cooling fan tachometer line 160 at a predetermined. period after powering on the computing system 110. The arrival of the predetermined period may be calculated or determined by a clock or other timing device on the cooling fan or on the computer system. In one aspect, the predetermined period represents a fixed time as calculated by the timing device. The time may be calculated from a specific reference point such as powering on the computer, completing a specific task, etc. In another aspect, the predetermined period may represent a point in a process and not a time. For example, certain tasks may be performed in a certain order and transmittal of cooling fan identification information may take place once preceding tasks have been completed. Even the same or similar tasks may take differing amounts of time to complete each time the task is performed, so a fixed time period in some embodiments may be less desirable. In another aspect. the predetermined period is a more nebulous period, e.g., regular or irregular period, which may change depending on various factors. For example, the predetermined time period can be a period of a certain level of minimal fan use. The cooling fan may transmit identification information when being operated at a specific low duty cycle. This may be at one or more points when fan usage reaches a specific low point, or when fan usage or projected fan usage is at a low duty cycle for a certain amount of time. In one aspect, the predetermined period may be configured by a user. In another aspect, the predetermined period may be determined or configured by software or hardware of the computing system and the predetermined period may be static or dynamic. In another aspect, the predetermined period may be a fixed inconfigurable period. In at least some computing systems, there is a period after the computing system is turned on or powered on before the system is able to control the cooling fan through voltages or PWM values. This period may be the predetermined period during which cooling fan identification information is transmitted. In one aspect, the system cooling fan may simply begin transmitting identification information before and/or up until the computing system is able to begin controlling cooling fan operation. The cooling fan may be configured to begin transmittal as soon as it receives power or at a period after receiving power. The cooling fan identification information may be sent once or repeatedly until the computing system begins controlling the cooling fan. The cooling fan may be configured to recognize a lack of control by the computing system and transmit cooling fan identification information. The cooling fan may also transmit identification information in response to coded instructions received from the computing system.

In accordance with another embodiment, cooling fan identification information can be sent after the computing system is able to control the cooling fan. For example, the predetermined period may be after a computer system has booted and an operating system has loaded. As the tachometer line may generally be being used at this point to transmit cooling fan speed information, use of the tachometer line to transmit speed. information may be temporarily stopped so that the tachometer line may be used to transmit cooling fan identification information instead. After the cooling fan identification information has been transmitted, the tachometer line can again be used to transmit cooling fan speed. information. In one aspect, the cooling fan may transmit a signal or sequence of signals through the tachometer line to indicate that cooling fan identification information is going to be transmitted. The sequence may be a predetermined sequence readable by the computer system. In embodiments where a cooling fan timing device determines the predetermined period, such a signal sequence may be necessary for the computer system to recognize the fan will send the cooling fan identification information. The cooling fan identification information may be sent once or repeatedly. The identification information may be sent at a specific point in the predetermined period. The identification information may be sent until the predetermined period has expired and/or the computing system again begins controlling the cooling fan. The cooling fan may be configured to recognize a lack of control by the computing system at the predetermined period and transmit cooling fan identification information. The cooling fan may also transmit identification information in response to coded instructions received. from the computing system.

While description of this method has referenced FIG. 1 and a three-pin connector fan, it is to be understood that four-pin connector fans or other types of fans may also implement this method for identifying cooling fan information.

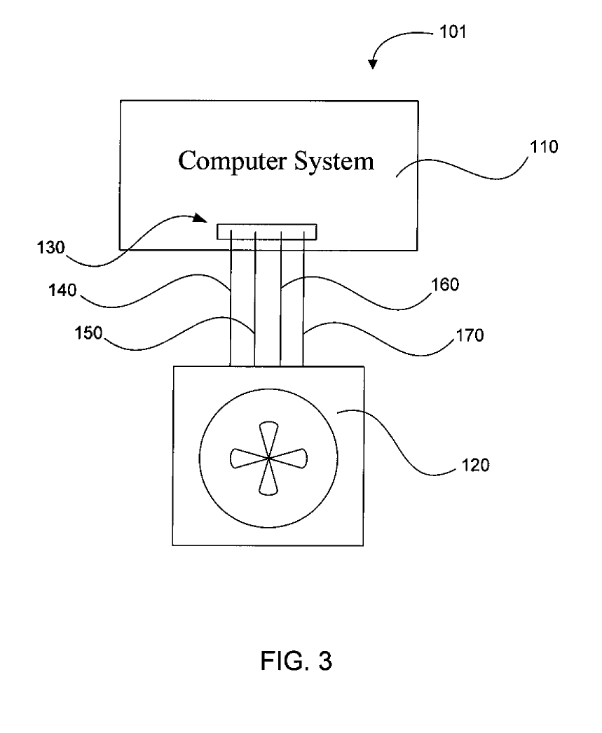

In another embodiment, as illustrated in FIG. 3, a system, indicated generally at 101, depicts an example embodiment which resembles a traditional four-pin connector cooling fan 120 connected to a computer system 110. The cooling fan is connected to a connection port 130 on the computer system through which voltages arc provided, signals sent, etc. As described above, the four-pin connector can include a wire for an electrical ground 140, a wire for providing a voltage 150, a wire for transmitting speed information 160, and a pulse width modulation control wire 170.

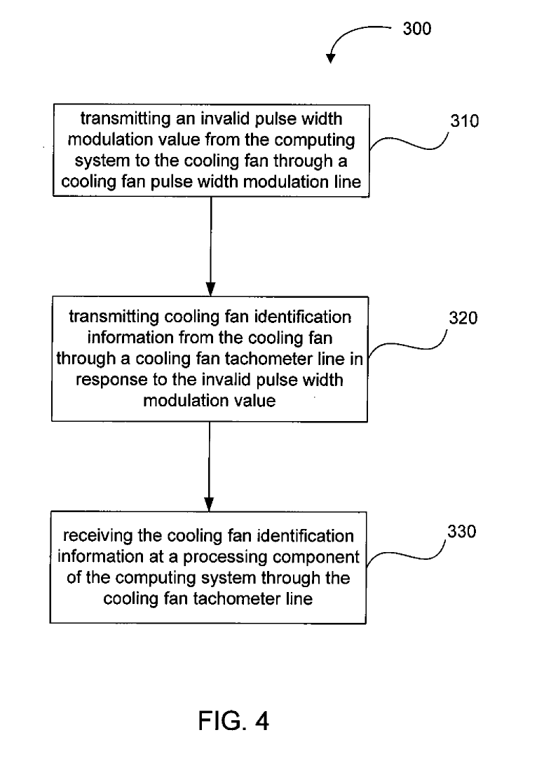

Reference will now be made to FIGS. 3 and 4. In accordance with one embodiment, the invention provides a method 300 for determining identifying information about a cooling fan for use in a computing system. In one step 310, an invalid pulse width modulation value may be transmitted to the cooling fan 120 through a cooling fan pulse width modulation line 170. As described above, PWM values may have a range of, for example, 0-127 or 1-127. Different cooling fans may have different acceptable values. Some cooling fans may not recognize values recognizable by other cooling fans. Some values may simply not be recognized by any cooling fan. The term “invalid pulse width modulation value” is used as indicating values outside of the numerical 0-127 or 1-127 range, For example, a 0 or an F (which may also be in the form of 00h or FFh) may be transmitted to the cooling fan.

To say that a value is invalid is not necessarily to say that the cooling fan does not recognize what to do in response to receipt of the invalid value. Rather, the value is invalid as to providing fan pulse width modulation. In other words, the term “invalid” in this context merely means that the typical pulse width modulation signal that would otherwise be expected is modified. This invalid value or signal then would illicit a response as it relates to embodiments of the present disclosure. Another step 320 of the method provides for transmitting cooling fan identification information through a cooling fan tachometer line 170 in response to an invalid pulse width modulation value. Thus, the cooling fan may be operable to perform other functions in response to such “invalid” PWM values.

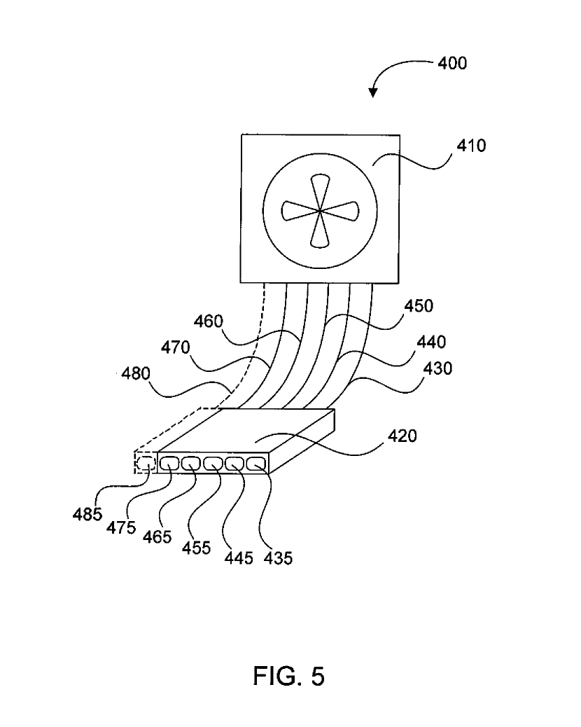

In another step 330, the method 300 provides for receiving the cooling fan identification information through the cooling fan tachometer line at a processing component of the computing system. As in method 200 described above, the cooling fan identification information may be transmitted using a sequence of tachometer signals. The method 300 is compatible with other described features of the above method 200. For example, the invalid pulse width modulation value may be sent at a predetermined time. The computing system can then determine sufficiency of the cooling fan to cool the computing system. A heat sink may be identified by identifying a cooling fan associated with the heat sink, and the computing system may determine sufficiency of the heat sink to dissipate heat. Additionally, a system cooling fan may be taken out of a command mode (the mode of fan operation for transmitting identification information) by sending a particular signal, such as a specific PWM signal or value or sequence of signals or values. In an alternative example embodiment illustrated in FIG. 5, a system, indicated generally at 400, includes a cooling fan 410 for use in a computing system. The cooling fan is capable of transmitting identifying information about the cooling fan. The system includes a cooling fan configured to provide cooling in a computing system. A fan connector 420 can be connected to the cooling fan and coupleable to the computing system. The fan connector may be configured to transmit identifying information between the cooling fan and the computing system, in addition to providing functionality in three- and four-pin connector fans and others. In one aspect, the fan connector may comprise at least five connector pins (and five associated wires or lines). A first connector 435 and line 430 may be configured to connect to an electrical ground. A second connector 445 and line 440 may be configured to provide a voltage to the cooling din. A third connector 455 and line 450 may be configured to communicate rotation information of the cooling fan to the computing system. A fourth connector 465 and line 460 may be configured to communicate a request for identification information from the computing system to the fan identification module. A fifth connector 475 and line 470 may be configured to communicate fan identification information from the fan identification module to the computing system.

In accordance with one aspect of the embodiment, the cooling fan system 400 may further include a sixth connector 485 and line 480 configured to communicate pulse width modulation control information from the computing system to the cooling fan.

The cooling fan system 400 may further comprise a fan identification module. The fan identification module may be configured to store and transmit fan identification information in response to requests for fan identification information from the computing system. The fan identification module may be a hardware or software solution as understood by one having skill in the art.

In another embodiment of the invention, a system cooling fan including at least a four-pin fan connector haying a PWM control line, the cooling fan may be configured to transmit cooling fan identification information when triggered over the PWM control line. For example, the PWM input may be driven at a different frequency than normal operation. In another aspect, the computing: system may send. coded commands to the cooling fan using the PWM input. Such commands may be general (e.g., send all identifying information) or specific e.g., send only manufacturer information, or send only manufacturer and model information).

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for determining identifying information about a system cooling fan for use in a computing system, comprising:
powering on the computing system, including the cooling fan;
transmitting cooling fan identification information through a cooling fan tachometer line at a predetermined period after powering on the computing system; and
receiving the cooling fan identification information through the cooling fan tachometer line at a processing component of the computing system.

2. A method as in claim 1, wherein the predetermined period, comprises a period, after the computing system is powered on and before the system is able to control the cooling fan.

3. A method as in claim 1 or 2, wherein the processing component of the computing system is a system BIOS.

4. A method as in one of claims 1-3, further comprising temporarily stopping use of the tachometer line to transmit speed information at the predetermined period to use the tachometer line to transmit the cooling fan identification information.

5. A method as in one of claims 1-4, wherein the predetermined period is configurable by a user.

6. A method as in one of claims 1-5, wherein the predetermined period is determined by the computing system.

7. A method as in one of claims 1-6, wherein the predetermined period is determined by a timing module on the fan configured to send a predetermined sequence of tachometer signals to indicate to the computing system that the cooling fan will send the cooling fan identification information.

8. A method as in one of claims 1-7, wherein the cooling fan identification information is transmitted using a sequence of tachometer signals.

9. A method for determining identifying information about a cooling fan for use in a computing system, comprising:
transmitting an invalid pulse width modulation value from the computing system to the cooling fan through a cooling fan pulse width modulation line;
transmitting cooling fan identification information from the cooling fan through a cooling fan tachometer line in response to the invalid pulse width modulation value; and
receiving the cooling fan identification information at a processing component of the computing system through the cooling fan tachometer line.

10. A method as in claim 9, wherein the invalid wise width modulation value is sent at a predetermined time.

11. A method as in claim 9 or 10, wherein the cooling fan identification information is transmitted using a sequence of tachometer signals.

12. A method as in one of claims 9-11, further comprising identifying a heat sink by identifying a cooling fan associated with the heat sink.

13. A cooling fan system for use in a computing system and capable of transmitting identifying information, comprising:
a) a cooling fan configured to provide cooling in a computing system;
b) a fan connector connected to the cooling fan and coupleable to the computing system, said fan configured to transmit information between the cooling fan and the computing system and comprising at least five connectors, wherein:
i) a first connector is configured to connect to an electrical ground;
ii) a second connector is configured to provide a voltage to the cooling fan;
iii) a third connector is configured to communicate rotation information of the cooling fan to the computing system;
iv) a fourth connector is configured to communicate an identification request from the computing system to the fan identification module; and
v) a fifth connector is configured to communicate fan identification information from the fan identification module to the computing system.

14. A cooling fan system as in claim 13, further comprising a sixth connector configured to communicate pulse width modulation control information from the computing system to the cooling fan.

15. A cooling fan system as in claim 13 or 14, further comprising a fan identification module configured to store and transmit fan identification information in response to requests for fan identification information from the computing system.
